(19) United States
(12) Patent Application Publication
(10) Pub. No.: US 2013/0143460 A1
(43) Pub. Date: Jun. 6, 2013

(54) HIGH PERFORMANCE COMPOSITE FABRIC

(71) Applicant: Jason Beck, Peoria, AZ (US)

(72) Inventor: Jason Beck, Peoria, AZ (US)

(73) Assignee: TYR TACTICAL, LLC, Peoria, AZ (US)

(21) Appl. No.: 13/161,322

(22) Filed: Jun. 15, 2011

Related U.S. Application Data
(60) Provisional application No. 61/355,089, filed on Jun. 15, 2010.
(60) Provisional application No. 61/384,560, filed on Sep. 20, 2010.

(51) Int. Cl. B32B 5/26; B29C 70/18

(52) U.S. Cl. 442/239; 156/324

(57) ABSTRACT

Methods and apparatus are provided for a durable, wear resistant composite fabric. In one exemplary embodiment the composite fabric comprises an outer layer of a woven synthetic fabric, and a backing layer of a woven fabric made from high tenacity fibers. The backing layer may be consolidated with the outer layer.

### TECHNICAL FIELD

The present invention generally relates to durable fabrics suitable for use in various ruggedized garments, gear, and equipment; including tactical equipment and clothing articles such as anti-ballistic vests and the like.

### DESCRIPTION OF THE EMBODIMENTS

The present invention as described hereinafter may be embodied in many different forms and should not be construed as limited to the embodiments set forth. Rather, these embodiments are provided so that this disclosure will be operative, enabling, and complete. Accordingly, the particular arrangements disclosed are meant to be illustrative only and not limiting as to the scope of the invention. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

According to one exemplary embodiment of the invention, a lightweight tactical material comprises a composite of a synthetic fabric outer layer combined with a backing layer made from a high strength, damage resistant material. The synthetic outer layer may be for example a high-performance Nylon-6,6 product presently manufactured by Invista, a wholly owned division of Koch Industries Inc., and sold under the trade name Cordura®. Cordura is used in a wide range of products from luggage and backpacks to boots, military apparel (such as tactical blade sheaths and ammunition pouches), and performance apparel. The weight of nylon fabric used in the composite material of the present invention may be between about 200 and 1000 denier, and in one particular embodiment the weight is about 500 denier.

The backing of the composite material may be made of high tenacity polymer fibers, such as various aramid fibers, high performance polyethylene fibers, and the like. Due to their remarkably high tensile strength-to-weight ratio, such fibers have many applications, including for example bicycle tires, racing sails, mooring lines, and body armor. Specific high tenacity fibers suitable for the composite material of the present invention include but are not limited to Kevlar®, a para-aramid synthetic fiber manufactured by DuPont™; Twaron, another para-aramid fiber with roughly the same chemical structure, manufactured by Teijin Aramid; terephthaloyl chloride (TCl), an aramid fiber closely related to para-aramids, also manufactured by Teijin Aramid and sold under the name Technora®; and high molecular weight polyethylene (HMWPE) such as commercially known Spectra®. Other suitable materials include polybenzobisoxazole fibers (PBO) sold under the name ZYLON™ by Toyobo Co. Ltd., of Osaka, Japan, and heat resistant aramid fiber products such as Dupont's Nomex® and Protera® fabrics. Such fibers may have a tensile strength greater than about 2000 MPa (or greater than about 7 grams per denier) and an elastic modulus greater than about 60 GPa. Moreover, there have been generations of fibers and fabrics made from these fibers which have evolved over the years beginning with the first generation of ballistic nylon; second generation of Kevlar® 29, Kevlar® 49, Twaron and Spectra®; third generation of Twaron T-2000 Microfilament, Kevlar® 129 and Kevlar® LT fabrics; and fourth generation of Araflex™.

In one exemplary embodiment of a backing layer, high performance polymer fibers are utilized in the form of a woven fabric, including for example woven fabrics generally used for repelling and trapping hand driven sharp objects such as knives, awls, shanks and the like. Depending upon the particular intended use, an exemplary woven fabric may be constructed from yarn of anywhere between about 100 and 1200 denier, and aerial densities in the range of 3 to 10 ounces per square yard (“OSY”). For example, fabrics constructed of yarns in the 200 to 300 denier range, and aerial densities in the 3 to 4 OSY range are generally preferred for items such as pouches, small duffels, backpacks and the like. Alternatively for heavier applications such as large suitcases or equipment bags, larger yarns in the 700 to 1200 denier range, and densities in the 7 to 10 OSY range may be preferable.

The woven fabric of the backing layer may be formed of a relatively tight, puncture resistant weave, comprising for example at least 40 fibers per inch in a first, or warp direction, and at least 40 fibers per inch in a second, or fill direction. In one particular embodiment the backing layer comprises a weave with between 60 and 72 fibers per inch in both the warp and fill directions. In addition, the fabric may be formed by tightly weaving multi-filament yarns to obtain a warp yarn “density” or “cover” in excess of 100 percent at the center of the fill yarn, and a fill yarn density or cover in excess of 75 percent as measured between two warp ends. Such tight weaves may comprise in excess of 100 fibers per inch in the warp and fill directions, and filament crossovers in the range of about 50,000,000 (fifty million) filament crossovers per square inch up to 90,000,000 (ninety million) filament crossovers per square inch. An exemplary tightly woven, puncture resistant fabric suitable for a backing layer is disclosed in U.S. Pat. No. 5,565,264, the entire contents of which are hereby incorporated by referenced.

In one particularly embodiment, the backing layer is Dupont™ Kevlar® Correctional™, a tightly woven Kevlar® fabric. Kevlar Correctional is advertized as an extremely tight weave utilizing filaments one fourth the size of comparable materials. Another suitable commercially available material is a woven puncture resistant product sold under the trademark TURTLESKIN by Warwick Mills, Inc., of New Ipswich, N.H. These products are available in various weights, with 200 and 300 denier sizes particularly preferred for construction of lightweight personal gear such as packs and pouches, and fabric weights in the 500 to 1000 denier range preferable for larger, heavier articles such as large suitcases and equipment duffels.

The nylon outer material and backing layer are preferably consolidated, or laminated into a unitary composite fabric using any suitable technique such as bonding, stitching, and the like. Suitable bonding methods include for example the use of various types of adhesives, such as air-drying adhesives, chemically setting adhesives, radiation activated adhesives such as UV activated dental adhesives, hot-melt adhesives, and pressure sensitive adhesives. An adhesive may be pre-applied on at least one of the surfaces or materials to be joined, or separately introduced during a lamination process. In one embodiment, two or more fabrics layers are laminated under heat and pressure using a solid, polymer based thermoplastic adhesive, such as a polyamide, polyester, elastomeric urethane, or polyolefin polymer. One particular suitable product is a dry, non-woven mat, or web of a polymer-based thermoplastic manufactured by Spunfab Adhesive Fabrics of Cuyahoga Falls, Ohio. Another suitable material is a class of thermoplastic adhesives by 3M sold under the name “Stitchless Bonding Films”. The fabric layers and the thermoplastic adhesive may be supplied from respective adjacent spools, and fed through a laminating machine with the thermoplastic web sandwiched between the fabric layers. An exemplary hot melt laminating process is described for example in U.S. Pat. No. 5,547,536, the entire contents of which are hereby incorporated by reference.

As noted above, the two fabrics of the present invention may also be consolidated using various types of Pressure Sensitive Adhesives, also referred to as “PSA”s. PSAs are distinguished from most other types of adhesives in that they bond on contact, rather than through a solidifying process such as evaporation, chemical reaction, or melting. PSAs are usually based on an elastomer compounded with a suitable tackifier (e.g., a rosin ester). Suitable elastomers include those based on natural rubber, Nitriles, Butyl rubber, Acrylics, Styrene block copolymers, vinyl ethers, Ethylene-vinyl acetate, and various silicon rubbers. In one exemplary embodiment the PSA comprises an acrylic adhesive such as 3M's family of VHB™ permanent assembly tapes. Another suitable PSA is 3M adhesive# 9485PC, an acrylic sheet approximately 5 mils thick, and sold in rolls up to 48 inches wide.

The strength of the high performance fiber backing makes the composite material particularly beneficial in high wear areas of garments or equipment. Examples of high wear areas include corners of ammunition pouches, fragmentation pouches, radio communication pouches, and armor pockets in armor plate carriers. In ballistic vests and ballistic armor carriers the combination of materials also increases longevity and strength of the key load carriage points, particularly once the material is sewn through. Seams can be further strengthened by folding the seam over to double or triple thickness prior to stitching. In addition, any tears or de-laminations in the outer layer can be temporarily field repaired by re-attaching the damaged outer fabric to the intact backing using a fast setting adhesive such as Cyanoacrylate (referred to generically as “Superglue”) liquid adhesive. Alternatively, if portions of the outer layer are missing or worn away making re-attachment impractical, the intact backing can instead simply be left exposed, and if desired, temporarily disguised using a suitably colored paint or ink marker.

Although the composite fabric has been described primarily in terms of an outer layer and a backing layer, the fabric may comprise additional or different layers. For example, the composite fabric may comprise two or more outer layers, or two or more backing layers, or multiple layers of each. In addition, the layers may be arranged in various configurations, such as two backing layers on one side of a single outer layer, or a sandwich configuration with an outer layer on either side of one or more backing layers. The composite fabric may also be combined with various other material layers, such as a liner made of a breathable or insulative type of fabric or material. The additional materials may be consolidated or attached to an outer layer or backing layer using any of the above described methods and materials. Further, various other combinations of layers and materials are contemplated as foreseeable, and intended to fall within the scope of the high performance composite fabric.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under §112, 6th paragraph is not intended. Additionally, it is not intended that the scope of patent protection afforded the present invention be defined by reading into any claim a limitation found herein that does not explicitly appear in the claim itself.

What is claimed is:

1. A durable, wear resistant composite fabric, comprising:
an outer layer of a woven synthetic fabric; and
a backing layer of a woven fabric made from high tenacity fibers, the backing layer consolidated with the outer layer.

2. The composite material of claim 1, wherein the outer layer is made of nylon.

3. The composite material of claim 1, wherein the backing layer is made of high performance polymer fibers.

4. The composite material of claim 3, wherein the high performance polymer fibers are selected from the group comprising aramid fibers, para-aramid fibers, high molecular weight polyethylene fibers, polybenzobisoxazole fibers, and terephthaloyl chloride fibers.

5. The composite material of claim 3, wherein the backing layer is formed of a puncture resistant, relatively tight weave, comprising at least 40 fibers per inch in a first, warp direction, and at least 40 fibers per inch in a second, fill direction.

6. The composite material of claim 5, wherein the puncture resistant backing layer is characterized by a warp yarn density in excess of 100 percent, and a fill yarn density in excess of 75 percent.

7. The composite material of claim 5, wherein the relatively tight weave of the backing layer comprises filament crossovers in the range of about fifty million to ninety million filament crossovers per square inch.

8. The composite material of claim 1, wherein the backing layer is consolidated with the outer layer through a laminating process using a thermoset adhesive.

9. The composite material of claim 1, wherein the backing layer is Kevlar® Correctional™ para-aramid fiber fabric.

10. The composite material of claim 1, wherein the fibers may have a tensile strength greater than about 2000 MPa, and an elastic modulus greater than about 60 GPa.

11. The composite material of claim 1, wherein the fibers have a tensile strength greater than about 7 grams per denier.

12. A composite fabric, comprising:
a first layer of a woven synthetic fabric; and
a second layer comprising a woven fabric formed of a puncture resistant, relatively tight weave of high performance fibers, with at least 40 fibers per inch in a first, warp direction, and at least 40 fibers per inch in a second, fill direction.

13. The composite fabric of claim 12, wherein the puncture resistant second layer is characterized by a warp yarn density in excess of 100 percent, and a fill yarn density in excess of 75 percent.

14. The composite fabric of claim 12, wherein the first layer is made of nylon.

15. The composite material of claim 12, wherein the high performance polymer fibers are selected from the group comprising aramid fibers, para-aramid fibers, high molecular weight polyethylene fibers, polybenzobisoxazole fibers, and terephthaloyl chloride fibers.

16. The composite fabric of claim 12, wherein the backing layer is consolidated with the outer layer through a laminating process using a thermoset adhesive.

17. The composite fabric of claim 16, further comprising a third fabric layer attached to one of the first and second fabric layers.

18. The composite fabric of claim 12, wherein the fibers may have a tensile strength greater than about 2000 MPa, and an elastic modulus greater than about 60 GPa.

19. The composite fabric of claim 12, wherein the second layer comprises between about 60 and 72 fibers per inch in both the warp and fill directions.

20. A composite fabric, comprising:
a first fabric layer of a wear resistant, synthetic material; and
a second fabric layer comprising Kevlar® Correctional™ brand woven para-aramid fiber fabric laminated to the first fabric layer.

21. The composite fabric of claim 20, wherein the second layer is laminated to the first layer using a thermoplastic adhesive.

22. The composite fabric of claim 21, wherein the second layer is laminated to the first layer using a pressure sensitive adhesive.

23. The composite fabric of claim 20, wherein the first layer is woven nylon.

24. A method of manufacturing a high performance composite fabric, comprising:
providing a first woven fabric made of a synthetic fiber;
positioning a second woven fabric made from high tenacity fibers adjacent the first woven fabric; and
consolidating the first and second woven fabrics into a unitary composite.

25. The method of manufacturing a high performance composite fabric of claim 24, wherein the first and second woven fabrics are consolidated under heat and pressure using a thermoplastic bonding agent.

26. The method of manufacturing a high performance composite fabric of claim 25, wherein the second woven fabric includes high performance polymer fibers selected from the group comprising aramid fibers, para-aramid fibers, high molecular weight polyethylene fibers, polybenzobisoxazole fibers, and terephthaloyl chloride fibers.

27. The method of manufacturing a high performance composite fabric of claim 26, wherein the fibers of the second woven fabric have a tensile strength greater than about 2000 MPa, and an elastic modulus greater than about 60 GPa.
